(19) United States
(12) Patent Application Publication
(10) Pub. No.: US 2004/0066841 A1
(43) Pub. Date: Apr. 8, 2004

(54) Systems, methods of operating, and computer program products for selecting delays for a rake receiver based on signal to interference ratios and/or powers

(76) Inventor: Elias Jonsson, Malmo (SE)

Correspondence Address: MYERS BIGEL SIBLEY & SAJOVEC, PO BOX 37428, RALEIGH, NC, 27627, US

(21) Appl. No.: 10/608,241

(22) Filed: Jun. 27, 2003

Related U.S. Application Data
(60) Provisional application No. 60/412,899, filed on Sep. 23, 2002.

(51) Int. Cl. H04B 1/707

(52) U.S. Cl. 375/148

(57) ABSTRACT

Delays for a RAKE receiver are selected by searching a plurality of multi-paths to select a set of multi-path delays associated with the highest signal to interference ratios (SIRs) and/or power values. The respective SIR values and/or power values for the multi-path delays are averaged over a time interval and the averaged SIR values and/or power values are multiplied by a scaling factor so as to reduce the averaged SIR values and/or power values. Those multi-path delays from the set of multi-path delays and a previous set of multi-path delays that have SIR values and/or power values greater than a threshold value are selected to generate a monitored set of multi-path delays. The SIR values and/or power values associated with the monitored set of multi-path delays are filtered and at least one multi-path delay from the monitored set of multi-path delays is eliminated as being correlated with another multi-path delay of the monitored set of multi-path delays to generate an output set of multi-path delays. The output set of multi-path delays are provided to a RAKE receiver.

### RELATED APPLICATION

This application claims the benefit of Provisional Application No. 60/412,899, filed Sep. 23, 2002, the disclosure of which is hereby incorporated herein by reference.

### BACKGROUND OF THE INVENTION

The present invention relates to communication methods and electronic devices, and, more particularly, to spread spectrum communication methods and electronic devices.

Wireless communications systems are commonly used to provide voice and data communications to subscribers. For example, analog cellular radiotelephone systems, such as those designated AMPS, ETACS, NMT-450, and NMT-900, have long been deployed successfully throughout the world. Digital cellular radiotelephone systems such as those conforming to the North American standard IS-54 and the European standard GSM have been in service since the early 1990's. More recently, a wide variety of wireless digital services broadly labeled as PCS (Personal Communications Services) have been introduced, including advanced digital cellular systems conforming to standards such as IS-136 and IS-95, lower-power systems such as DECT (Digital Enhanced Cordless Telephone) and data communications services such as CDPD (Cellular Digital Packet Data). These and other systems are described in The Mobile Communications Handbook, edited by Gibson and published by CRC Press (1996).

Several types of access techniques are conventionally used to provide wireless services to users of wireless systems. Traditional analog cellular systems generally use a system referred to as Frequency Division Multiple Access (FDMA) to create communications channels, wherein discrete frequency bands serve as channels over which cellular terminals communicate with cellular base stations. Typically, these bands are reused in geographically separated cells in order to increase system capacity.

Modern digital wireless systems typically use different multiple access techniques such as Time Division Multiple Access (TDMA) and/or Code Division Multiple Access (CDMA) to provide increased spectral efficiency. In TDMA systems, such as those conforming to the GSM or IS-136 standards, carriers are divided into sequential time slots that are assigned to multiple channels such that a plurality of channels may be multiplexed on a single carrier. CDMA systems, such as those conforming to the IS-95 standard, achieve increased channel capacity by using “spread spectrum” techniques wherein a channel is defined by modulating a data-modulated carrier signal by a unique spreading code, i.e., a code that spreads an original data-modulated carrier over a wide portion of the frequency spectrum in which the communications system operates. The spreading code typically includes a sequence of “chips” occurring at a chip rate that is higher than the bit rate of the data being transmitted.

A so-called RAKE receiver structure is commonly used to recover information corresponding to one of the user data streams. In a typical RAKE receiver, a received composite signal is correlated with a particular spreading sequence assigned to the receiver to produce a plurality of time-offset correlations, a respective one of which corresponds to an echo of a transmitted spread spectrum signal. The correlations are then combined in a weighted fashion, i.e., respective correlations are multiplied by respective weighting factors and then summed to produce a decision statistic. The correlations generally are performed in a plurality of correlating fingers in the RAKE receiver, wherein each finger is synchronized with a channel path. The outputs of all fingers are combined to allow an improvement in the overall signal-to-noise ratio of the received signal. The design and operation of RAKE receivers are well known to those having skill in the art and need not be described further herein.

To maintain the RAKE receiver fingers synchronized with their respective channel paths, a path searcher may be used to support the RAKE receiver. The path searcher can continuously search for new channel paths and estimate their delays. These delays are then assigned to the RAKE fingers. For a wideband CDMA (WCDMA) system, the detection of the multi-path delays is typically done as a two-stage process: In the first stage, a wide search is done to identify the location of the multi-path delays. The resolution of this first search (i.e., the separation between the delays) is typically one chip or less. Typically, the received power or signal to interference ratio (SIR) is used as a criterion for the quality of the delayed signal. In the second stage, a localized search is performed over selected regions of delays. The resolution of this second search is typically one-half chip to an eighth of a chip. A decision is then made as to which delays to use for despreading the data based on the information from the localized search.

Unfortunately, it may be difficult to select which localized region of delays to monitor, to update the monitored delays, and to select the final delays used for despreading the data. One approach is to select the best delays (delays with the highest powers and/or SIRs) from the localized search and then to follow those delays as they fade and move in time. The best ones of these delays is then used for despreading the data. Unfortunately, clearly defined peaks may not be available when examining the power or SIR profile versus the delay. Complicated rules may, therefore, be needed to extract peaks out of a profile that contains few, if any, sharp peaks.

### SUMMARY OF THE INVENTION

According to some embodiments of the present invention, delays for a RAKE receiver are selected by searching a plurality of multi-paths to select a set of multi-path delays associated with the highest signal to interference ratios (SIRs) and/or power values. The respective SIR values and/or power values for the multi-path delays are averaged over a time interval and the averaged SIR values and/or power values are multiplied by a scaling factor so as to reduce the averaged SIR values and/or power values. The multi-path delays from the set of multi-path delays and a previous set of multi-path delays that have SIR values and/or power values greater than a threshold value are selected to generate a monitored set of multi-path delays. This selection may allow the total number of delays to be deduced. The SIR values and/or power values associated with the monitored set of multi-path delays are filtered and at least one multi-path delay from the monitored set of multi-path delays is eliminated as being correlated with another multi-path delay of the monitored set of multi-path delays to generate an output set of multi-path delays. The output set of multi-path delays is provided to a RAKE receiver.

Although described above primarily with respect to method aspects of the present invention, it will be understood that the present invention may be embodied as methods, systems, and/or computer program products.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a mobile terminal receiver in accordance with some embodiments of the present invention;

FIGS. 2, 3A, 3B, 4A, 4B, and 5 are flowcharts that illustrate operations for selecting delays for tuning the fingers of a RAKE receiver, in accordance with some embodiments of the present invention; and

FIG. 6 is a timeline that illustrates operations for selecting delays for tuning the fingers of a RAKE receiver, in accordance with some embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof.

The present invention may be embodied as systems, e.g., electronic devices, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein in the context of selecting delays for a RAKE receiver in a mobile terminal receiver. It will be understood, however, that the present invention may be embodied in other types of electronic devices that incorporate a RAKE receiver. Moreover, as used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices. The present invention is also described herein in the context of selecting delays for a RAKE receiver based on signal to interference ratios (SIR). It will be understood, however, that, in accordance with some embodiments of the present invention, power values may be used in addition to or in place of the SIR values.

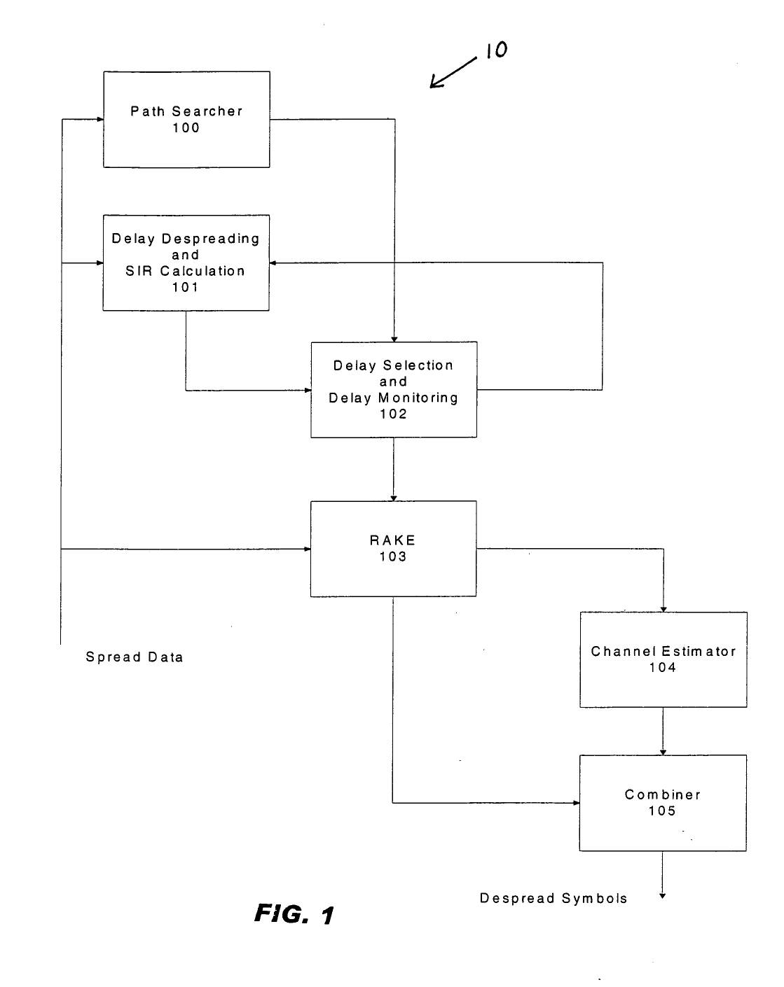

Referring now to FIG. 1, a mobile terminal receiver 10, in accordance with some embodiments of the present invention, comprises a path searcher module 100, a delay despreading and signal to interference ratio (SIR) calculation module 101, a delay selection and monitoring module 102, a RAKE receiver module 103, a channel estimator module 104, and a combiner module 105 that are configured as shown. The path searcher module 100 is configured to conduct a wide search to find possible multi-path delays for active channels to be demodulated. Possible multi-path delays are generally characterized by large power values. Typically, the resolution of the search performed by the path searcher module 100 is on the order of one chip. The delay despreading and SIR calculation module 101 is configured to compute the SIR profile for the selected delays to be monitored and potential delays to be included in the SIR profile. The resolution of the delays processed by the delay despreading and SIR calculation module 101 is generally much finer than the resolution used by the path searcher module 100. The delay selection and monitoring module 102 is configured to control when the path searcher module 100 performs a new search, to evaluate the possible new delays obtained from the path searcher, to determine when and how to update the SIR profile for the monitored delays, and to decide which delays to be provided to the RAKE receiver 103 for despreading an incoming signal containing spread data.

The RAKE receiver module 103 is configured to combine multi-path signals together so as to exploit channel diversity. The receiver module 103 is called a RAKE receiver because it “rakes” several multi-path contributions together. The RAKE receiver module 103 comprises a number of processing units or RAKE fingers. When demodulating a multi-path fading channel, each finger of the RAKE receiver is synchronized with one of the diverse propagation paths of the channel. A RAKE receiver comprising L fingers is able to detect L copies of the transmitted signal, which are corrected for time delays and added coherently. The resulting signal comprises a collection of several of the time-delayed copies of the transmitted signal. Generally, the RAKE receiver fingers are assigned to the strongest set of multi-path signals. As discussed above, the delay selection and monitoring module 102 determines which set of delays to use in tuning the fingers of the RAKE receiver.

The channel estimator module 104 is configured to estimate the channel gain and phase to produce traffic symbols, which are then provided to the combiner module 105, which combines the traffic symbols to produce a despread, received signal.

Although FIG. 1 illustrates an exemplary hardware and/or software architecture that may be used to select delays for tuning the fingers of a RAKE receiver, it will be understood that the present invention is not limited to such a configuration but is intended to encompass any configuration capable of carrying out the operations described herein. It will be further appreciated that the functionality of any or all of the processing modules of FIG. 1 may also be implemented using discrete hardware components, one or more application specific integrated circuits (ASICs), or a programmed digital signal processor or microcontroller.

The present invention is described hereinafter with reference to flowchart and/or block diagram illustrations of methods, electronic devices, and computer program products in accordance with some embodiments of the invention. These flowchart and/or block diagrams further illustrate exemplary operations of the mobile terminal architecture of FIG. 1. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Before describing exemplary operations for selecting delays for tuning the fingers of a RAKE receiver, in accordance with some embodiments of the present invention, exemplary operations for selecting a subset of multi-path delays from a set of multi-path delays, for expanding the number of multi-path delays that are candidates for monitoring, and for reducing the SIR values for selected multi-path delays that are correlated to one another will be described first.

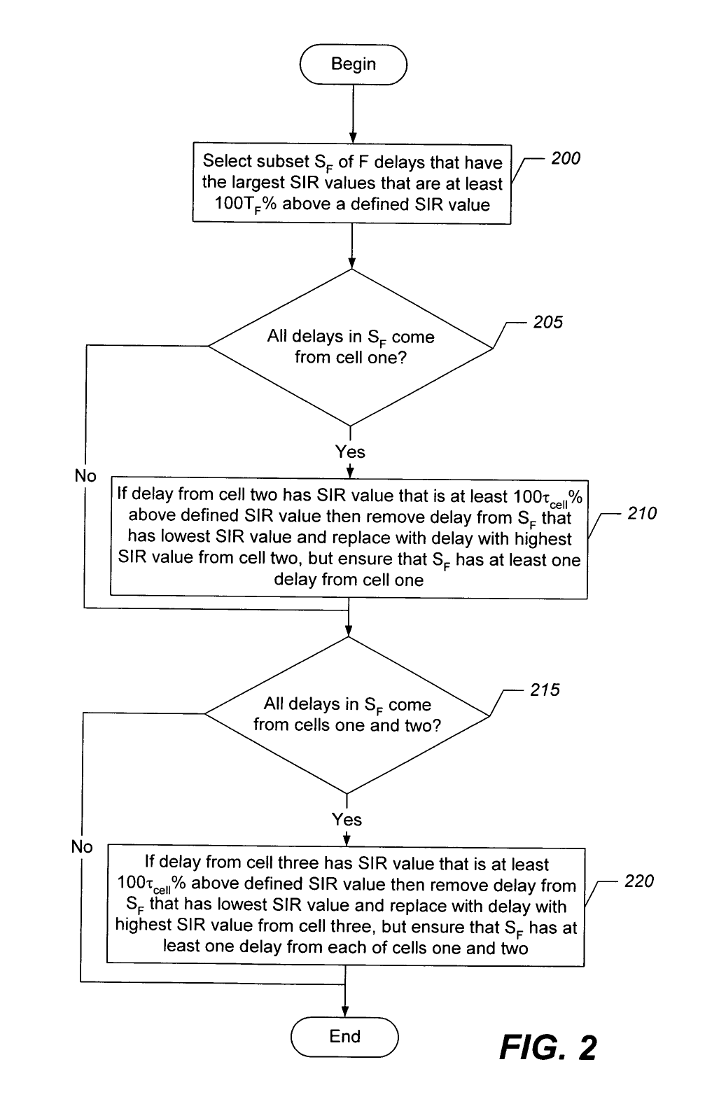

Referring now to FIG. 2, exemplary operations for selecting a subset of multi-path delays from a set of multi-path delays, in accordance with some embodiments of the present invention, begin at block 200 where a subset S_{F} of F multi-path delays having the largest SIR values that are at least 100τ_{F}% above a defined SIR value is selected from a set of multi-path delays. If the F multi-path delays come from a first wireless cell as determined at block 205, then if a multi-path delay from a second wireless cell has an SIR value that is at least 100τ_{Cell}% above the defined SIR value, then the multi-path delay in S_{F} that has the lowest SIR value is removed from S_{F} and replaced with the multi-path delay with highest SIR value from cell two at block 210. Verification is made, however, to ensure that the subset S_{F} has at least one multi-path delay from cell one. This is done because the paths of cell two are uncorrelated with the paths from cell one and, therefore, a cell two multi-path may provide a valuable contribution in demodulating the multi-path signals.

At block 215, a determination is made whether all of the F multi-path delays in S_{F} come from cells one and two. If this is the case, then if a multi-path delay from a third wireless cell has an SIR value that is at least 100τ_{cell}% above the defined SIR value, then the multi-path delay in S_{F} that has the lowest SIR value is removed from S_{F} and replaced with the multi-path delay with highest SIR value from cell three at block 220. Verification is made, however, to ensure that the subset S_{F} has at least one multi-path delay from cells one and two. As will be understood by those skilled in the art, the operations described above may be extended to four or more cells

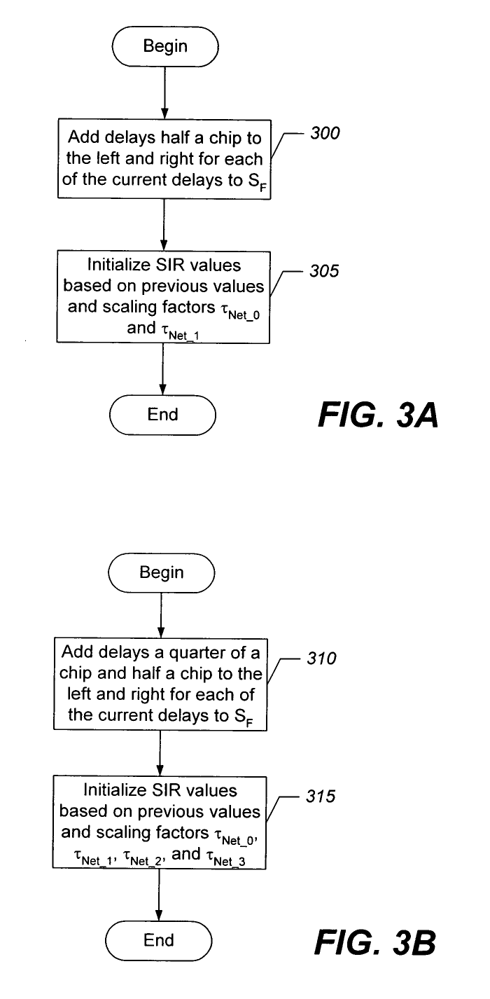

Referring now to FIGS. 3A and 3B, exemplary operations for expanding the number of multi-path delays that are candidates for monitoring, in accordance with some embodiments of the present invention, will now be described. FIG. 3A illustrates exemplary operations for expanding the number of multi-path delays that are candidates for monitoring when the resolution of the SIR profile (set of multi-path delays and SIR values that are provided to the RAKE receiver 103) is not significantly greater than the resolution of the path searcher module 100. Operations begin at block 300 where multi-path delays half a chip to the left and right of the existing multi-path delays in the set S_{F} are added to the set S_{F}. If the new multi-path delays do not have SIR values associated with a previous SIR profile, then the SIR values are initialized to 100τ_{Net}_{_{—}}₁% of the smallest SIR value of its left and right neighbors if both exist, or to 100τ_{Net}_{_{—}}₀% of either the left or right neighbor if only one neighbor exists at block 305.

FIG. 3B illustrates exemplary operations for expanding the number of multi-path delays that are candidates for monitoring when the resolution of the SIR profile is four or eight times the resolution of the path searcher module 100. Operations for the case where the resolution of the SIR profile is four times the resolution of the path searcher module 100 begin at block 310 where multi-path delays a quarter of a chip and a half a chip to the left and right of the existing multi-path delays in the set S_{F} are added to the set S_{F}. If the new multi-path delays do not have SIR values associated with a previous SIR profile, then the SIR values are initialized based on scaling factors τ_{Net}_{_{—}}₀, τ_{Net}_{_{—}}₁, τ_{Net}_{_{—}}₂, τ_{Net}_{_{—}}₃ at block 315 as follows: For multi-path delays a quarter chip away, the SIR values are initialized to 100τ_{Net}_{_{—}}₁% of the smallest SIR value of its left and right neighbors if both exist, or to 100τ_{Net}_{_{—}}₀% of either the left or right neighbor if only one neighbor exists. For multi-path delays a half chip away, the SIR values are initialized to 100τ_{Net}_{_{—}}₂% of the smallest SIR value of its left and right neighbors if both exist, or to 100τ_{Net}_{_{—}}₃% of either the left or right neighbor if only one neighbor exists.

It will be understood those that the operations described above with respect to FIGS. 3A and 3B can be extended to more general cases in accordance with some embodiments of the present invention.

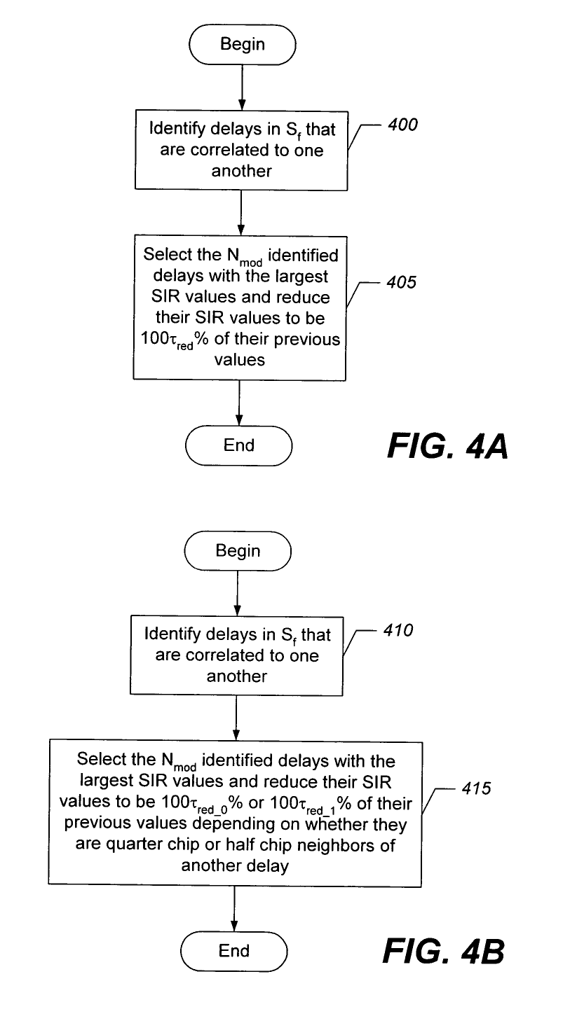

Referring now to FIGS. 4A and 4B, exemplary operations for reducing the SIR values for selected multi-path delays that are correlated to one another, in accordance with some embodiments of the present invention, will now be described. FIG. 4A illustrates exemplary operations for reducing the SIR values for selected multi-path delays that are correlated to one another when the resolution of the SIR profile is not significantly greater than the resolution of the path searcher module 100. Operations begin at block 400 where the multi-path delays in the set S_{F} that are correlated with one another are identified. In accordance with some embodiments of the present invention, this may be done by selecting the multi-path delay having the largest SIR value and then tagging its neighbors within a half chip with the value N. Next, the multi-path delay with the second largest SIR value not already tagged by N is selected and its half chip neighbors are tagged with the value N. This procedure continues until all of the multi-path delays in the set S_{F} have been examined. At block 405, the N_{mod} delays tagged by N and having the largest SIR values are scaled such that their SIR values are reduced to be 100τ_{red}% of their previous values. By reducing the importance of such correlated delays, other more uncorrelated delays are given priority, which may improve performance of the RAKE receiver 103.

FIG. 4B illustrates exemplary operations for reducing the SIR values for selected multi-path delays that are correlated to one another when the resolution of the SIR profile is four or eight times the resolution of the path searcher module 100. Operations for the case where the resolution of the SIR profile is four times the resolution of the path searcher module 100 begin at block 410 where the multi-path delays in the set S_{F} that are correlated with one another are identified. In accordance with some embodiments of the present invention, this may be done by selecting the multi-path delay having the largest SIR value and then tagging its neighbors within a quarter chip with the value N₀ and its neighbors between a quarter chip and half chip away with N₁. Next, the multi-path delay with the second largest SIR value not already tagged by N₀ or N₁ is selected and its quarter chip and half chip neighbors are tagged as described above. This procedure continues until all of the multi-path delays in the set S_{F} have been examined. At block 415, the N_{mod} delays tagged by N₀ or N₁ and having the largest SIR values are scaled such that their SIR values of those delays tagged by N₀ are reduced to be 100τ_{red}_{_{—}}₀% of their previous values and those delays tagged by N₁ are reduced to be 100τ_{red}_{_{—}}₁% of their previous values.

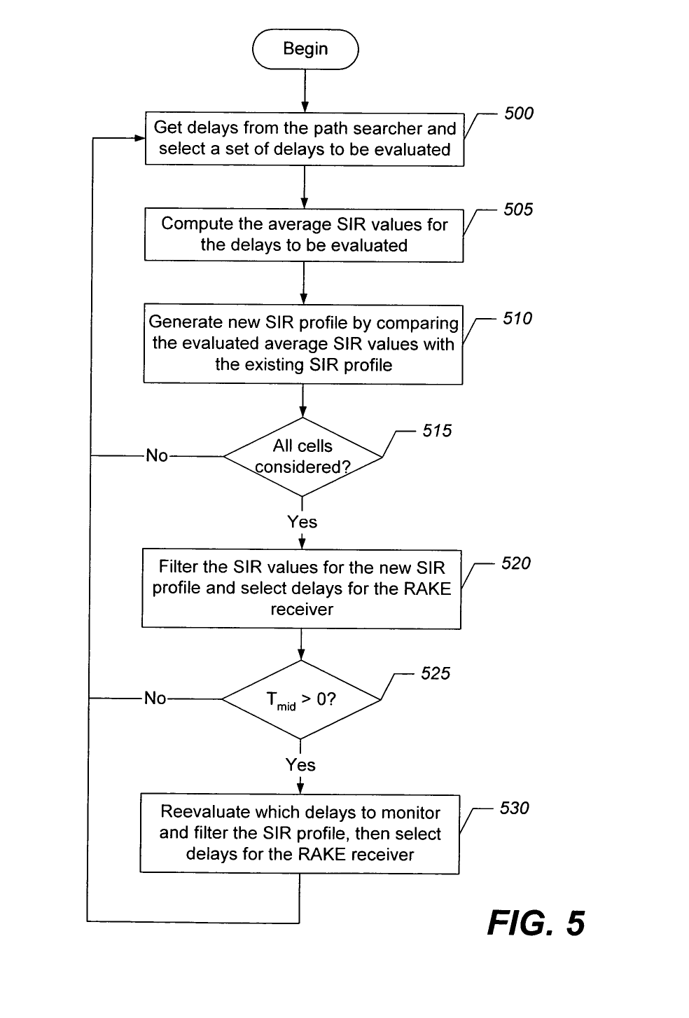

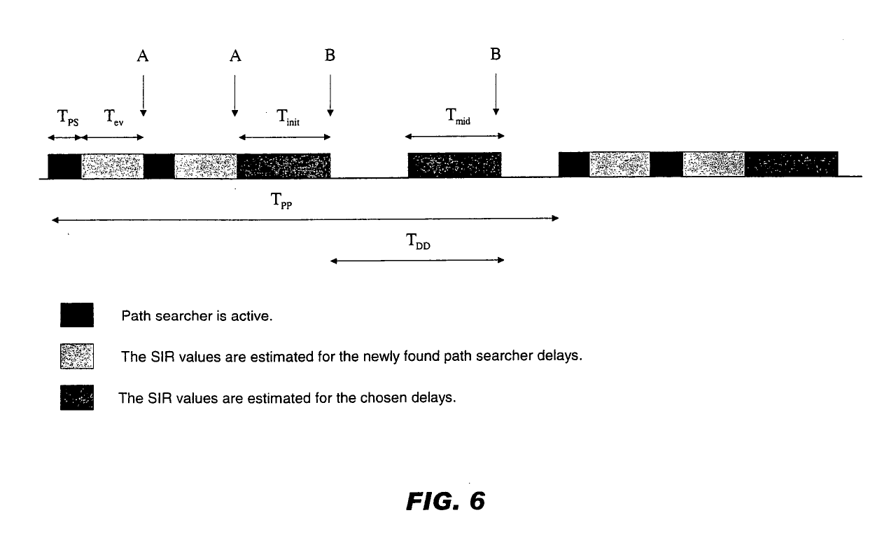

Referring now to FIGS. 5 and 6, exemplary operations for selecting delays for tuning the fingers of a RAKE receiver, in accordance with some embodiments of the present invention, will now be described. Operations begin at block 500 where multi-path delays are obtained from the path searcher 100 and a set of delays to be evaluated is selected. In accordance some exemplary embodiments, a path search is performed over a period of T_{PS} slots as shown in FIG. 6 and Nₑᵥ delays associated with the maximum SIR peaks are selected. The operations of FIGS. 3A or 3B are then performed to expand the number of multi-path delays that are candidates for monitoring. The set of multi-path delays obtained after performing the operations of FIGS. 3A or 3B is given by S_{PS} and the multi-path delays in the current SIR profile is given by S_{B}.

At block 505, the average SIR values for the set of multi-path delays S_{PS} are computed over a period of Tₑᵥ time slots. The average SIR value for a multi-path delay f is given by Equation 1, where SIR_{f}⁽ⁿ⁾ is the instantaneous SIR value for sample n and SIR_{filt,f}⁽ⁿ⁾ is its filtered counterpart, which is discussed in detail below:

$${SIR}_{avg , f} = \frac{{SIR}_{filt , f}^{( n )} + {\sum }_{k = n + 1}^{n + {N}_{ev}} {SIR}_{f}^{( k )}}{{N}_{ev} + 1} \qquad EQ . 1$$

At block 510, the evaluated average SIR values are compared with the existing SIR profile to generate a new SIR profile at time point A shown in FIG. 6. In some embodiments, the averaged SIR values from block 505 are multiplied by a scaling factor ρ. This may allow older multi-path delays currently in the SIR profile to be given priority over newer multi-path delays. If the sets S_{PS} and S_{B} contain common multi-path delays, then the maximal SIR values are used for those paths as indicated by Equation 2:

$${SIR}_{filt , f}^{( n )} = max ( {SIR}_{filt , f}^{( n )} , {SIR}_{avg , f} ) \qquad EQ . 2$$

This reduces the likelihood that the multi-path delays that have already been incorporated into the SIR profile are moved out. The operations for reducing the SIR values for selected multi-path delays that are correlated to one another of FIGS. 4A and 4B with N_{mod}=N_{mod}_{_{—}}ₘₒₙ, τ_{red}=τ_{red}_{_{—}}ₘₒₙ or τ_{red}_{_{—}}₀=τ_{red}_{_{—}}₀_{_{—}}ₘₒₙ, and τ_{red}_{_{—}}₁=τ_{red}_{_{—}}₁_{_{—}}ₘₒₙ are applied to the union of S_{PS} and S_{B} to create a temporary profile. The multi-path delay selection operations of FIG. 2 with τ_{F}=τ_{F}_{_{—}}ₘₒₙ and τ_{Cell}=τ_{Cell}_{_{—}}ₘₒₙ, and F=Fₘₒₙ are applied to the temporary profile to generate a set of multi-path delays used for delay monitoring. The operations of FIGS. 3A or 3B are then performed (initialization is done using the original profile) to expand the number of multi-path delays that are candidates for monitoring to generate the resulting set of multi-path delays S_{B}. As indicated by block 515 and the two time points labeled A in FIG. 6, the operations of blocks 500, 505, and 510 are repeated for all cells.

At block 520, the SIR values for the set of multi-path delays S_{B} for Tᵢₙᵢₜ time slots are filtered using the filter parameter αᵢₙᵢₜ according to Equation 3 below:

$${SIR}_{filt , f}^{( n + 1 )} = {α}_{init} {SIR}_{filt , f}^{( n )} + ( 1 - {α}_{init} ) {SIR}_{f}^{( n )} \qquad EQ . 3$$

The operations for reducing the SIR values for selected multi-path delays that are correlated to one another of FIGS. 4A and 4B with N_{mod}=N_{mod}_{_{—}}_{RAKE}, τ_{red}_{_{—}}₀=τ_{red}_{_{—}}₀_{_{—}}_{RAKE}, and τ_{red}_{_{—}}₁=τ_{red}_{_{—}}₁_{_{—}}_{RAKE} are then applied to the set of multi-path delays S_{B} and stored as a temporary profile. This will alter the SIR profile such that if two delays are highly correlated, one of them is essentially dropped. The multi-path delay selection operations of FIG. 2 with F=F_{RAKE}, τ_{F}=τ_{F}_{_{—}}_{RAKE} and τ_{Cell}=τ_{Cell}_{_{—}}_{RAKE} are applied to the temporary profile to generate a set of multi-path delays used for tuning the fingers of the RAKE receiver 103.

At block 525 a determination is made whether any time exists between the end of the Tᵢₙᵢₜ interval and the path searcher module 100 providing new multi-path delays. These time slots are labeled T_{mid} on FIG. 6. If T_{mid} is greater than zero slots, then at block 530 the operations for reducing the SIR values for selected multi-path delays that are correlated to one another of FIGS. 4A and 4B with N_{mod}=N_{mod}_{_{—}}ₘₒₙ, τ_{red}=τ_{red}_{_{—}}ₘₒₙ or τ_{red}_{_{—}}₀=τ_{red}_{_{—}}₀_{_{—}}ₘₒₙ, and τ_{red}_{_{—}}₁=τ_{red}_{_{—}}₁_{_{—}}ₘₒₙ are applied to S_{B} to create a temporary profile. The multi-path delay selection operations of FIG. 2 with τ_{F}=τ_{F}_{_{—}}ₘₒₙ and τ_{Cell}=τ_{Cell}_{_{—}}ₘₒₙ, and F=Fₘₒₙ are then applied to the set of multi-path delays S_{B} in the temporary profile. The operations of FIGS. 3A or 3B are then performed to expand the number of multi-path delays in the set S_{B} that are candidates for monitoring. Initialization is done using the original profile. The operations of block 520 are then performed to filter the SIR values for the multi-path delays in the set S_{B} using Equation 3. The end of the T_{mid} time slots corresponds to the second instance of the label B on FIG. 6. The operations for reducing the SIR values for selected multi-path delays that are correlated to one another of FIGS. 4A and 4B with N_{mod}−N_{mod}_{_{—}}_{RAKE}, τ_{red}_{_{—}}₀=τ_{red}_{_{—}}₀_{_{—}}_{RAKE}, and τ_{red}_{_{—}}₁=τ_{red}_{_{—}}₁_{_{—}}_{RAKE} are then applied to the set of multi-path delays S_{B} and stored as a temporary profile. This will alter the SIR profile such that if two delays are highly correlated, one of them is essentially dropped. The multi-path delay selection operations of FIG. 2 with F=F_{RAKE}, τ_{F}=τ_{F}_{_{—}}_{RAKE} and τ_{Cell}=τ_{Cell}_{_{—}}_{RAKE} are applied to the temporary profile to generate a set of multi-path delays used for tuning the fingers of the RAKE receiver 103. The operations of block 530 may be repeated multiple times before returning to block 500.

The flowcharts of FIGS. 2, 3A, 3B, 4A, 4B, and 5 illustrate the architecture, functionality, and operations of embodiments of the mobile terminal receiver 10 of FIG. 1 hardware and/or software. In this regard, each block represents a module, segment, or portion of code, which comprises one or more executable instructions for implementing the specified logical function(s). It should also be noted that in other implementations, the function(s) noted in the blocks may occur out of the order noted in FIGS. 2, 3A, 3B, 4A, 4B, and 5. For example, two blocks shown in succession may, in fact, be executed substantially concurrently or the blocks may sometimes be executed in the reverse order, depending on the functionality involved.

TABLE 1 below includes a list of the parameters discussed above along with exemplary ranges for each parameter and a recommended value for each parameter in accordance with some embodiments of the present invention.

TABLE 1

| Parameter | Range | Recommended Value |
|---|---|---|
| Fₘₒₙ | 8-30 | 15 |
| F_{RAKE} | 5-15 | 10 |
| τ_{red}_RAKE | 0-0.5 | .25 |
| τ_{red}_mon | 0-0.5 | 0 |
| τ_{red}_0_RAKE | 0-0.5 | 0.15 |
| τ_{red}_0_mon | 0-0.5 | 0 |
| τ_{red}_1_RAKE | 0-0.5 | 0.25 |
| τ_{red}_1_mon | 0-0.5 | 0.1 |
| τ_{cell}_RAKE | 0.1-1.0 | 0.2 |
| τ_{cell}_mon | 0.1-1.0 | 0.2 |
| τ_{F}_RAKE | 0-0.2 | 0.05 |
| τ_{F}_mon | 0-0.2 | 0 |
| N_{mod}_mon | 0-Fₘₒₙ | Fₘₒₙ |
| N_{mod}_RAKE | 0-F_{RAKE} | F_{RAKE} |
| αᵢₙᵢₜ | 0.5-1 | 0.985 |
| Nₑᵥ | 1-25 | 15 |
| Tᵢₙᵢₜ | 1-25 | 20 |
| T_{mid} | 1-25 | 20 |

Many variations and modifications can be made to the preferred embodiments without substantially departing from the principles of the present invention. All such variations and modifications are intended to be included herein within the scope of the present invention, as set forth in the following claims.

That which is claimed:

1. A method of selecting delays for a RAKE receiver, comprising:
searching a plurality of multi-paths to select a set of multi-path delays associated with the highest signal to interference ratios (SIRs) and/or power values;
averaging the respective SIR values and/or power values for the multi-path delays over a time interval;
selecting those multi-path delays from the set of multi-path delays and a previous set of multi-path delays that have SIR values and/or power values greater than a threshold value to generate a monitored set of multi-path delays;
filtering the SIR values and/or power values associated with the monitored set of multi-path delays;
eliminating at least one multi-path delay from the monitored set of multi-path delays as being correlated with another multi-path delay of the monitored set of multi-path delays to generate an output set of multi-path delays; and
providing the output set of multi-path delays to a RAKE receiver.

2. The method of claim 1, wherein the searching, averaging, and multiplying are performed for a plurality of different cells.

3. The method of claim 1, wherein selecting those multi-path delays from the set of multi-path delays and the previous set of multi-path delays that have SIR values and/or power values greater than the threshold value comprises:
selecting those multi-path delays from the set of multi-path delays and the previous set of multi-path delays that have SIR values and/or power values greater than the threshold value such that the selected multi-path delays are associated with a plurality of cells.

4. The method of claim 1, wherein the threshold value is a first threshold value, and wherein selecting those multi-path delays from the set of multi-path delays and the previous set of multi-path delays that have SIR values and/or power values greater than the first threshold value such that the selected multi-path delays are associated with the plurality of cells comprises:
replacing a multi-path delay associated with a first cell that has a smallest SIR value and/or power value associated therewith with a multi-path delay associated with a second cell that has an SIR value and/or power value greater than a second threshold value.

5. The method of claim 1, further comprising:
expanding the monitored set of multi-path delays by adding multi-path delays to the monitored set of multi-path delays that are within a half chip of existing ones of the monitored set of multi-path delays.

6. The method of claim 5, further comprising:
initializing the SIR values and/or power values for those multi-path delays added to the monitored set of multi-path delays while expanding based on SIR values and/or power values associated with the previous set of multi-path delays.

7. The method of claim 5, further comprising:
initializing the SIR values and/or power values for those multi-path delays added to the monitored set of multi-path delays while expanding by using a first scaling factor for respective ones of those added multi-path delays that have both left and right neighbor multi-path delays and by using a second scaling factor for respective ones of those added multi-path delays that have only a left or right neighbor multi-path delay.

8. The method of claim 5, further comprising:
initializing the SIR values and/or power values for those multi-path delays added to the monitored set of multi-path delays while expanding by using a first scaling factor for respective ones of those added multi-path delays that have both left and right neighbor multi-path delays and are within a quarter chip of an existing one of the multi-path delays, using a second scaling factor for respective ones of those added multi-path delays that have only a left or right neighbor multi-path delay and are within a quarter chip of an existing one of the multi-path delays, using a third scaling factor for respective ones of those added multi-path delays that have both left and right neighbor multi-path delays and are between a quarter chip and a half chip away from an existing one of the multi-path delays, and using a fourth scaling factor for respective ones of those added multi-path delays that have only a left or right neighbor multi-path delay and are between a quarter chip and a half chip away from an existing one of the multi-path delays.

9. The method of claim 1, wherein eliminating the at least one multi-path delay from the monitored set of multi-path delays comprises:
reducing SIR values and/or power values associated with selected ones of the monitored set of multi-path delays based on their correlation with other ones of the monitored set of multi-path delays; and
eliminating those multi-path delays from the monitored set of multi-path delays that have SIR values and/or power values less than the threshold value.

10. The method of claim 1, wherein the monitored set of multi-path delays is a first monitored set of multi-path delays, the threshold value is a first threshold value, the output set of multi-path delays is a first output set of multi-path delays, and wherein the method further comprises:
selecting those multi-path delays from the output set of multi-path delays that have SIR values and/or power values greater than the first threshold value to generate a second monitored set of multi-path delays;
expanding the second monitored set of multi-path delays by adding multi-path delays to the second monitored set of multi-path delays that are within a half chip of existing ones of the second monitored set of multi-path delays;
filtering the SIR values and/or power values associated with the second monitored set of multi-path delays;
selecting those multi-path delays from the second monitored set of multi-path delays that have SIR values and/or power values greater than a second threshold value to generate a third monitored set of multi-path delays;
eliminating at least one multi-path delay from the third monitored set of multi-path delays as being correlated with another multi-path delay of the third monitored set of multi-path delays to generate a fourth monitored set of multi-path delays;
selecting those multi-path delays from the fourth monitored set of multi-path delays that have SIR values greater than the second threshold value to generate an output set of multi-path delays; and
providing the second output set of multi-path delays to a RAKE receiver.

11. The method of claim 1, further comprising:
multiplying the averaged SIR values and/or power values by a scaling factor so as to reduce the averaged SIR values and/or power values before selecting those multi-path delays from the set of multi-path delays and the previous set of multi-path delays that have SIR values and/or power values greater than the threshold value to generate the monitored set of multi-path delays.

12. The method of claim 1, wherein selecting those multi-path delays from the set of multi-path delays and the previous set of multi-path delays that have SIR values and/or power values greater than the threshold value to generate the monitored set of multi-path delays comprises:
determining if the set of multi-path delays and the previous set of multi-path delays includes any common multi-path delays; and
associating with respective ones of the common multi-path delays a maximum SIR value and/or power value of the SIR value and/or power value associated with respective ones of the common multi-path delays in the set of multi-path delays and the SIR value and/or power value associated with respective ones of the common multi-path delays in the previous set of multi-path delays.

13. A system for selecting delays for a RAKE receiver, comprising:
means for searching a plurality of multi-paths to select a set of multi-path delays associated with the highest signal to interference ratios (SIRs) and/or power values;
means for averaging the respective SIR values and/or power values for the multi-path delays over a time interval;
means for selecting those multi-path delays from the set of multi-path delays and a previous set of multi-path delays that have SIR values and/or power values greater than a threshold value to generate a monitored set of multi-path delays;
means for filtering the SIR values and/or power values associated with the monitored set of multi-path delays;
means for eliminating at least one multi-path delay from the monitored set of multi-path delays as being correlated with another multi-path delay of the monitored set of multi-path delays to generate an output set of multi-path delays; and
means for providing the output set of multi-path delays to a RAKE receiver.

14. The system of claim 13, wherein the means for selecting those multi-path delays from the set of multi-path delays and the previous set of multi-path delays that have SIR values and/or power values greater than the threshold value comprises:
means for selecting those multi-path delays from the set of multi-path delays and the previous set of multi-path delays that have SIR values and/or power values greater than the threshold value such that the selected multi-path delays are associated with a plurality of cells.

15. The system of claim 13, wherein the threshold value is a first threshold value, and wherein the means for selecting those multi-path delays from the set of multi-path delays and the previous set of multi-path delays that have SIR values and/or power values greater than the first threshold value such that the selected multi-path delays are associated with the plurality of cells comprises:
means for replacing a multi-path delay associated with a first cell that has a smallest SIR value and/or power value associated therewith with a multi-path delay associated with a second cell that has an SIR value and/or power value greater than a second threshold value.

16. The system of claim 13, further comprising:
means for expanding the monitored set of multi-path delays by adding multi-path delays to the monitored set of multi-path delays that are within a half chip of existing ones of the monitored set of multi-path delays.

17. The system of claim 16, further comprising:
means for initializing the SIR values and/or power values for those multi-path delays added to the monitored set of multi-path delays while expanding based on SIR values and/or power values associated with the previous set of multi-path delays.

18. The system of claim 16, further comprising:
means for initializing the SIR values and/or power values for those multi-path delays added to the monitored set of multi-path delays while expanding by using a first scaling factor for respective ones of those added multi-path delays that have both left and right neighbor multi-path delays and by using a second scaling factor for respective ones of those added multi-path delays that have only a left or right neighbor multi-path delay.

19. The system of claim 16, further comprising:
means for initializing the SIR values and/or power values for those multi-path delays added to the monitored set of multi-path delays while expanding by using a first scaling factor for respective ones of those added multi-path delays that have both left and right neighbor multi-path delays and are within a quarter chip of an existing one of the multi-path delays, using a second scaling factor for respective ones of those added multi-path delays that have only a left or right neighbor multi-path delay and are within a quarter chip of an existing one of the multi-path delays, using a third scaling factor for respective ones of those added multi-path delays that have both left and right neighbor multi-path delays and are between a quarter chip and a half chip away from an existing one of the multi-path delays, and using a fourth scaling factor for respective ones of those added multi-path delays that have only a left or right neighbor multi-path delay and are between a quarter chip and a half chip away from an existing one of the multi-path delays.

20. The system of claim 13, wherein the means for eliminating the at least one multi-path delay from the monitored set of multi-path delays comprises:
means for reducing SIR values and/or power values associated with selected ones of the monitored set of multi-path delays based on their correlation with other ones of the monitored set of multi-path delays; and
means for eliminating those multi-path delays from the monitored set of multi-path delays that have SIR values and/or power values less than the threshold value.

21. The system of claim 13, wherein the monitored set of multi-path delays is a first monitored set of multi-path delays, the threshold value is a first threshold value, the output set of multi-path delays is a first output set of multi-path delays, and wherein the system further comprises:
means for selecting those multi-path delays from the output set of multi-path delays that have SIR values and/or power values greater than the first threshold value to generate a second monitored set of multi-path delays;
means for expanding the second monitored set of multi-path delays by adding multi-path delays to the second monitored set of multi-path delays that are within a half chip of existing ones of the second monitored set of multi-path delays;
means for filtering the SIR values and/or power values associated with the second monitored set of multi-path delays;
means for selecting those multi-path delays from the second monitored set of multi-path delays that have SIR values and/or power values greater than a second threshold value to generate a third monitored set of multi-path delays;
means for eliminating at least one multi-path delay from the third monitored set of multi-path delays as being correlated with another multi-path delay of the third monitored set of multi-path delays to generate a fourth monitored set of multi-path delays;
means for selecting those multi-path delays from the fourth monitored set of multi-path delays that have SIR values and/or power values greater than the second threshold value to generate an output set of multi-path delays; and
means for providing the second output set of multi-path delays to a RAKE receiver.

22. The system of claim 13, further comprising:
means for multiplying the averaged SIR values and/or power values by a scaling factor so as to reduce the averaged SIR values and/or power values before selecting those multi-path delays from the set of multi-path delays and the previous set of multi-path delays that have SIR values and/or power values greater than the threshold value to generate the monitored set of multi-path delays.

23. The system of claim 13, wherein the means for selecting those multi-path delays from the set of multi-path delays and the previous set of multi-path delays that have SIR values and/or power values greater than the threshold value to generate the monitored set of multi-path delays comprises:
means for determining if the set of multi-path delays and the previous set of multi-path delays includes any common multi-path delays; and
means for associating with respective ones of the common multi-path delays a maximum SIR value and/or power value of the SIR value and/or power value associated with respective ones of the common multi-path delays in the set of multi-path delays and the SIR value and/or power value associated with respective ones of the common multi-path delays in the previous set of multi-path delays.

24. A computer program product for selecting delays for a RAKE receiver, comprising:
a computer readable storage medium having computer readable program code embodied therein, the computer readable program code comprising:
computer readable program code configured to search a plurality of multi-paths to select a set of multi-path delays associated with the highest signal to interference ratios (SIRs) and/or power values;
computer readable program code configured to average the respective SIR values and/or power values for the multi-path delays over a time interval;
computer readable program code configured to select those multi-path delays from the set of multi-path delays and a previous set of multi-path delays that have SIR values and/or power values greater than a threshold value to generate a monitored set of multi-path delays;
computer readable program code configured to filter the SIR values and/or power values associated with the monitored set of multi-path delays;
computer readable program code configured to eliminate at least one multi-path delay from the monitored set of multi-path delays as being correlated with another multi-path delay of the monitored set of multi-path delays to generate an output set of multi-path delays; and
computer readable program code configured to provide the output set of multi-path delays to a RAKE receiver.

25. The computer program product of claim 24, wherein the computer readable program code configured to select those multi-path delays from the set of multi-path delays and the previous set of multi-path delays that have SIR values and/or power values greater than the threshold value comprises:
computer readable program code configured to select those multi-path delays from the set of multi-path delays and the previous set of multi-path delays that have SIR values and/or power values greater than the threshold value such that the selected multi-path delays are associated with a plurality of cells.

26. The computer program product of claim 24, wherein the threshold value is a first threshold value, and wherein the computer readable program code configured to select those multi-path delays from the set of multi-path delays and the previous set of multi-path delays that have SIR values and/or power values greater than the first threshold value such that the selected multi-path delays are associated with the plurality of cells comprises:
computer readable program code configured to replace a multi-path delay associated with a first cell that has a smallest SIR value and/or power value associated therewith with a multi-path delay associated with a second cell that has an SIR value and/or power value greater than a second threshold value.

27. The computer program product of claim 24, further comprising:
computer readable program code configured to expand the monitored set of multi-path delays by adding multi-path delays to the monitored set of multi-path delays that are within a half chip of existing ones of the monitored set of multi-path delays.

28. The computer program product of claim 27, further comprising:
computer readable program code configured to initialize the SIR values and/or power values for those multi-path delays added to the monitored set of multi-path delays while expanding based on SIR values and/or power values associated with the previous set of multi-path delays.

29. The computer program product of claim 27, further comprising:
computer readable program code configured to initialize the SIR values and/or power values for those multi-path delays added to the monitored set of multi-path delays while expanding by using a first scaling factor for respective ones of those added multi-path delays that have both left and right neighbor multi-path delays and by using a second scaling factor for respective ones of those added multi-path delays that have only a left or right neighbor multi-path delay.

30. The computer program product of claim 27, further comprising:
computer readable program code configured to initialize the SIR values and/or power values for those multi-path delays added to the monitored set of multi-path delays while expanding by using a first scaling factor for respective ones of those added multi-path delays that have both left and right neighbor multi-path delays and are within a quarter chip of an existing one of the multi-path delays, using a second scaling factor for respective ones of those added multi-path delays that have only a left or right neighbor multi-path delay and are within a quarter chip of an existing one of the multi-path delays, using a third scaling factor for respective ones of those added multi-path delays that have both left and right neighbor multi-path delays and are between a quarter chip and a half chip away from an existing one of the multi-path delays, and using a fourth scaling factor for respective ones of those added multi-path delays that have only a left or right neighbor multi-path delay and are between a quarter chip and a half chip away from an existing one of the multi-path delays.

31. The computer program product of claim 24, wherein the computer readable program code configured to eliminate the at least one multi-path delay from the monitored set of multi-path delays comprises:
computer readable program code configured to reduce SIR values and/or power values associated with selected ones of the monitored set of multi-path delays based on their correlation with other ones of the monitored set of multi-path delays; and
computer readable program code configured to eliminate those multi-path delays from the monitored set of multi-path delays that have SIR values and/or power values less than the threshold value.

32. The computer program product of claim 24, wherein the monitored set of multi-path delays is a first monitored set of multi-path delays, the threshold value is a first threshold value, the output set of multi-path delays is a first output set of multi-path delays, and wherein the system further comprises:
computer readable program code configured to select those multi-path delays from the output set of multi-path delays that have SIR values and/or power values greater than the first threshold value to generate a second monitored set of multi-path delays;
computer readable program code configured to expand the second monitored set of multi-path delays by adding multi-path delays to the second monitored set of multi-path delays that are within a half chip of existing ones of the second monitored set of multi-path delays;
computer readable program code configured to filter the SIR values and/or power values associated with the second monitored set of multi-path delays;
computer readable program code configured to select those multi-path delays from the second monitored set of multi-path delays that have SIR values and/or power values greater than a second threshold value to generate a third monitored set of multi-path delays;
computer readable program code configured to eliminate at least one multi-path delay from the third monitored set of multi-path delays as being correlated with another multi-path delay of the third monitored set of multi-path delays to generate a fourth monitored set of multi-path delays;
computer readable program code configured to select those multi-path delays from the fourth monitored set of multi-path delays that have SIR values and/or power values greater than the second threshold value to generate an output set of multi-path delays; and
computer readable program code configured to provide the second output set of multi-path delays to a RAKE receiver.

33. The computer program product of claim 24, further comprising:
computer readable program code configured to multiply the averaged SIR values and/or power values by a scaling factor so as to reduce the averaged SIR values and/or power values before selecting those multi-path delays from the set of multi-path delays and the previous set of multi-path delays that have SIR values and/or power values greater than the threshold value to generate the monitored set of multi-path delays.

34. The computer program product of claim 24, wherein the computer readable program code configured to select those multi-path delays from the set of multi-path delays and the previous set of multi-path delays that have SIR values and/or power values greater than the threshold value to generate the monitored set of multi-path delays comprises:
computer readable program code configured to determine if the set of multi-path delays and the previous set of multi-path delays includes any common multi-path delays; and
computer readable program code configured to associate with respective ones of the common multi-path delays a maximum SIR value and/or power value of the SIR value and/or power value associated with respective ones of the common multi-path delays in the set of multi-path delays and the SIR value and/or power value associated with respective ones of the common multi-path delays in the previous set of multi-path delays.

35. An electronic device, comprising:
a path searcher module that is configured to search a plurality of multi-paths to select a set of multi-path delays associated with the highest signal to interference ratios (SIRs) and/or power values;
a delay despreading and SIR calculation module that is configured to average the respective SIR values and/or power values for the multi-path delays over a time interval and to multiply the averaged SIR values and/or power values by a scaling factor so as to reduce the averaged SIR values and/or power values;
a delay selection and monitoring module that is configured to select those multi-path delays from the set of multi-path delays and a previous set of multi-path delays that have SIR values and/or power values greater than a threshold value to generate a monitored set of multi-path delays, to filter the SIR values and/or power values associated with the monitored set of multi-path delays; to eliminate at least one multi-path delay from the monitored set of multi-path delays as being correlated with another multi-path delay of the monitored set of multi-path delays to generate an output set of multi-path delays; and
a RAKE receiver having fingers tuned based on the output set of multi-path delays.
